(19) United States
(12) Patent Application Publication
(10) Pub. No.: US 2026/0253826 A1
(43) Pub. Date: Aug. 27, 2026

(54) SINGLE-PHASE CONTACTOR ACTUATION MECHANISM

(71) Applicant: Safran Power USA, LLC, Sarasota, FL (US)

(72) Inventor: Christopher Kenneth Wyatt, Bradenton, FL (US)

(21) Appl. No.: 18/879,355

(22) PCT Filed: Jul. 1, 2022
(86) PCT No.: PCT/US2022/035984

§ 371 Date: Dec. 27, 2024

(51) Int. Cl. H01H 50/54; H01H 50/64

(52) U.S. Cl. CPC H01H 50/541; H01H 50/645

(57) ABSTRACT

Described are electrical contactors. In an example, an electrical contactor includes a solenoid assembly configured to maintain a plunger rod in at least a normal position and a depressed position. The electrical contactor further includes a high voltage switch assembly that includes a pair of stationary high voltage contacts, an actuator configured to receive the plunger rod, a movable high voltage contact connected to the actuator and movable by the plunger rod, and a low voltage switch assembly. When in the normal position, the plunger rod causes the actuator to simultaneously separate the movable high voltage contact from the pair of stationary high voltage contacts and the low voltage switch assembly to toggle. When in the depressed position, the plunger rod causes the actuator to move the movable high voltage contact to contact with the pair of stationary high voltage contacts and the low voltage switch assembly to toggle.

### FIELD OF THE INVENTION

The field of the invention relates to electrical contactors. More specifically, and without limitation, this disclosure relates to improved electrical contactors that can switch multiple circuits simultaneously.

### BACKGROUND

Contactors are used to switch electrical circuits and in some cases, multiple electrical circuits at once. For example, a contactor can include a set of high voltage contacts that switch high-voltage circuits such as power supplies. Contactors can also include a second, or an auxiliary, set of contacts that switch low-voltage circuits simultaneously with the switching of the set of high voltage contacts. Switching these low-voltage circuits enables feedback that the switch has flipped via low voltage-operated status lights or turning on or off auxiliary circuits.

Contactors are often used in aerospace applications. Aerospace specifications often require that the high-voltage and low-voltage contacts make and break within a certain time tolerance. But due to the multiple components that are positioned in various locations within the contactor and are required to actuate both switches, and the tolerances of those components, configuring the contactor such that the switches operate simultaneously is difficult.

As such, existing solutions of manufacturing contactors can require special build processes and adjustments of the components during assembly. For instance, existing solutions often use a switch adjustment mechanism to adjust various components at assembly time. Then, when the contactor assembly is finished, the simultaneity is measured. If the simultaneity of the switching components remains too far away, then the contactor is be partially or fully disassembled and readjusted. This process is repeated until the contactor switch simultaneity is sufficient. Because this process is burdensome and difficult, new solutions are needed.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

According to certain embodiments of the present invention, an electrical contactor includes a solenoid assembly, a high voltage switch assembly, and a low voltage switch assembly. The solenoid assembly includes a plunger rod and is configured to maintain the plunger rod in at least a normal position and a depressed position. The high voltage switch assembly is configured to receive the plunger rod and includes a pair of stationary high voltage contacts; an actuator configured to receive the plunger rod and including one or more guides, each guide operable to mate with a respective stationary high voltage contact; and a movable high voltage contact connected to the actuator and movable by the plunger rod. The low voltage switch assembly is configured to receive the plunger rod and includes a stationary low voltage contact and a movable low voltage contact. The movable low voltage contact is movable by one or more ridges attached to the actuator. The ridges cause the low voltage switch assembly to toggle between a first position in which the movable low voltage contact contacts the stationary low voltage contact and a second position. The movable low voltage contact does not contact the stationary low voltage contact. When in the normal position, the plunger rod causes the actuator to simultaneously separate the movable high voltage contact from the pair of stationary high voltage contacts and the plunger rod causes the ridges to toggle the movable low voltage contact and the stationary low voltage contact. When in the depressed position, the plunger rod causes the actuator to (i) move the movable high voltage contact to contact with the pair of stationary high voltage contacts and (ii) the ridges to toggle the movable low voltage contact and the stationary low voltage contact.

According to certain embodiments of the present invention, a switch is provided. The switch includes a plunger assembly including a plunger rod, an actuator connected to the plunger rod, a movable high voltage contact connected to the actuator, a low voltage switch assembly, and a pair of stationary high voltage contacts. The low voltage switch assembly includes a stationary low voltage contact and a movable low voltage contact. The actuator and the plunger rod are configured to move between a first position and a second position. When the first position, the movable high voltage contact is separated from the pair of stationary high voltage contacts and the movable low voltage contact is separated from the stationary low voltage contacts. When in the second position, the movable high voltage contact makes contact with the pair of stationary high voltage contacts and the movable low voltage contact makes contact with the stationary low voltage contacts.

According to certain embodiments of the present invention, an actuator of an electrical contactor is provided. The actuator includes a first portion including a first guide extending through a first spring and operable to mate with a first stationary high voltage contact; a second portion including a second guide extending through a second spring and operable to mate with a second stationary high voltage contact, and a middle portion located between the first portion and the second portion. The middle portion is circular. The middle portion is configured to receive an attachment means. The attachment means attaches the actuator to one or more of the first stationary high voltage contact and the second stationary high voltage contact.

### BRIEF DESCRIPTION OF THE DRAWINGS

FIG. 1 is a cross section view of an electrical contactor, according to certain embodiments of the present invention.

FIG. 2 is a view of a plunger assembly of an electrical contactor, according to certain embodiments of the present invention.

FIG. 3, which includes FIGS. 3A and 3B, depicts views of an actuator of an electrical contactor, according to certain embodiments of the present invention.

FIG. 4, which includes FIGS. 4A, 4B, 4C, and 4D, depicts an attachment of a switch actuator to a contact, according to certain embodiments of the present invention.

FIG. 5, which includes FIGS. 5A, 5B, and 5C, is a view of a connection of a solenoid plunger rod to an actuator, according to certain embodiments of the present invention.

FIG. 6 is a view of an auxiliary board assembly on actuator, according to certain embodiments of the present invention.

FIG. 7 is a view of a low voltage switch assembly of the actuator, according to certain embodiments of the present invention.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Embodiments of the present invention relate to improved electrical contactors that enable switching of multiple circuits (e.g., a high voltage circuit and a low voltage circuit) simultaneously while eliminating or minimizing any adjustment necessary of components within the contactor at assembly time. Accordingly, disclosed systems lower cost and improve performance.

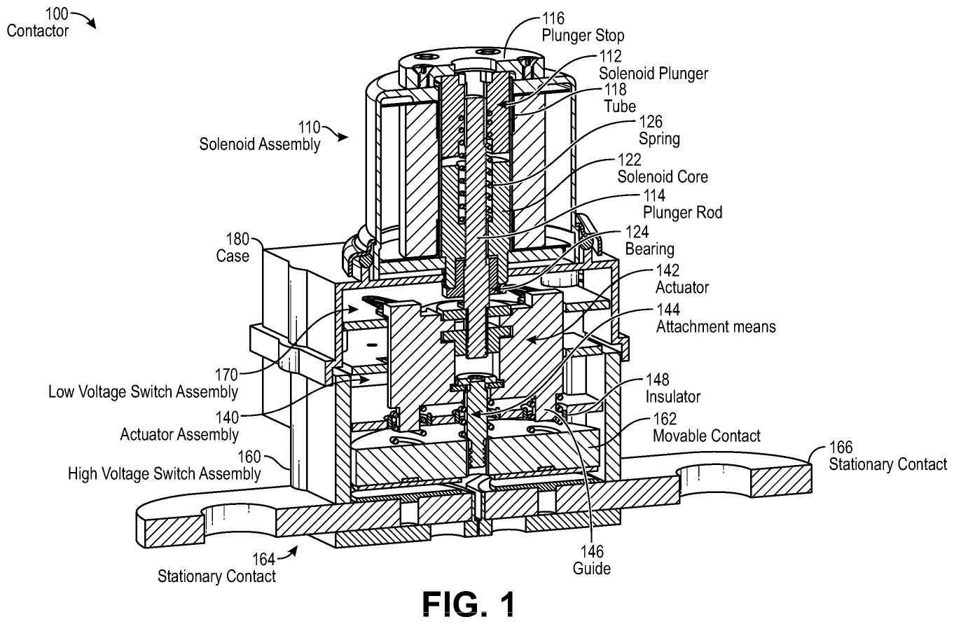

Turning now to the Figures, FIG. 1 is a cross section view of an electrical contactor, according to certain embodiments of the present invention. FIG. 1 depicts contactor 100, which includes a solenoid assembly 110, actuator assembly 140, high voltage switch assembly 160, low voltage switch assembly 170, and case 180. As depicted, solenoid assembly 110, low voltage switch assembly 170, actuator assembly 140 are within case 180. Components of high voltage switch assembly 160 extend outside case 180. But other arrangements are possible.

As depicted, contactor 100 includes two switch assemblies, but any number of switch assemblies are possible. Additional switch assemblies, in particular, low voltage switch assemblies, can also be included within contactor 100.

In an example, when solenoid assembly 110 is activated (e.g., by an electrical signal through a coil of solenoid assembly 110), solenoid assembly 110 causes an actuator within actuator assembly 140 to open or close or more switches in a synchronized manner. The design of contactor 100 electrically insulates all switches from one another and ensures that all the switches are sufficiently closely together to be able to use the single actuation component to actuate all switches simultaneously.

Solenoid assembly 110 includes solenoid plunger 112, plunger rod 114, plunger stop 116, tube 118, solenoid core 122, bearing 124, and spring 126. Solenoid plunger 112 is connected to plunger rod 114 and can be configured to maintain the plunger rod 114 in various positions. Plunger rod 114 can be attached with a nut, which is electrically isolated from all the switches and is held by the actuator 142 such that the nut will not rotate during assembly.

In one example, plunger rod 114 can move between a normal position (upright) and a depressed position (downward). When the plunger rod 114 is in the normal position, the contacts within high voltage switch assembly 160 are open. When the plunger rod 114 is in the downward position, the contacts within high voltage switch assembly 160 are closed. Low voltage switch assembly 170 can include sets of contacts that are normally open and sets of contacts that are normally closed.

Both solenoid plunger 112 and plunger rod 114 are cylindrical in shape. Tube 118 is cylindrical in shape and has as diameter greater than solenoid plunger 112 and plunger rod 114. Tube 118 can be made with metal such as brass. Spring 126 is configured to return plunger rod 114 to a normal position adjacent or proximate to plunger stop 116. Plunger rod 114 is free to travel in the center of solenoid core 122 in a linear direction, e.g., as depicted, upwards or downwards. Bearings 124 help smooth the movement of the plunger rod 114.

Solenoid core 122 includes one or more electric coils that allow for automatic switching of the circuits via energizing plunger rod 114, which in turn moves the actuator of actuator assembly 140. The coils can be energized with low voltage electric sources, e.g., 28 Volts DC. When current travels through the coils, the coils cause a magnetic force to be generated, which in turn causes plunger rod 114 to move downward into a depressed position. Conversely, when the current ceases to flow through the coils, the magnetic force is no longer generated, and spring 126 pushes the plunger rod 114 back upwards to the normal position, where the plunger rod 114 is stopped by plunger stop 116. In turn, this movement causes components within the actuator assembly to move, thereby toggling one or more switches such as high voltage switch assembly 160. In some cases, solenoid assembly 110 can be manually triggered, e.g., with force.

High voltage switch assembly 160 includes components for switching high voltage and/or high current circuits such as airplane accessory electrical supplies and so forth. High voltage switch assembly 160 includes movable contact 162, stationary contact 164, and stationary contact 166. When the actuator assembly 140 causes movable contact 162 to contact with stationary contact 164 and stationary contact 166, an electrical circuit is completed between stationary contact 164 and stationary contact 166. Movable contact 162, stationary contact 164, and stationary contact 166 are formed of an electrically conducting material such as copper, silver, aluminum, or an alloy.

Actuator assembly 140 includes actuator 142, attachment means 144, insulators 148, and guide 146. Actuator 142 is formed of a unique shape such that a single switch actuator can switch both low and high current circuits simultaneously and maintain insulation between contacts of the respective circuits and between the circuits. For example, high voltage contacts are insulated from low voltage contacts and vice versa. Actuator 142 can be formed of a single molded component (e.g., plastic) such that the actuator 142 is in direct contact with all switches and directly actuates all switches simultaneously.

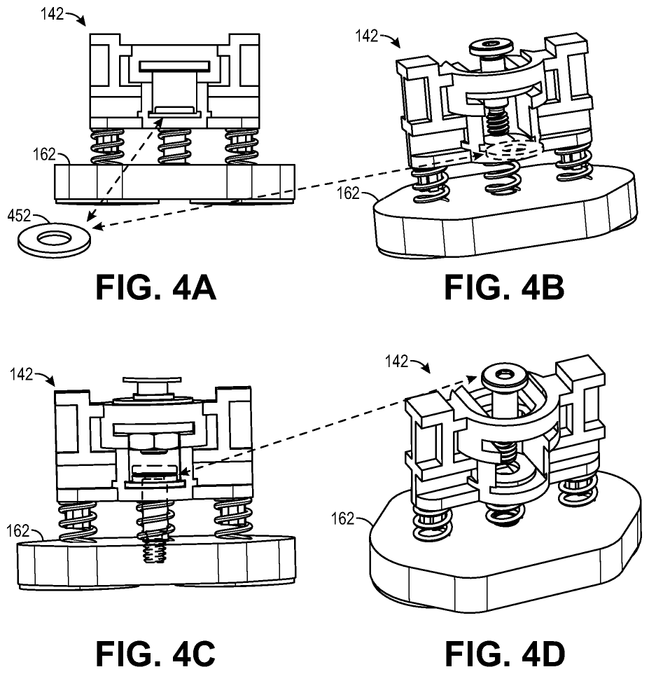

Actuator 142 can receive or be attached to plunger rod 114. In an example, plunger rod 114 is attached to actuator 142, for example, with simple washer piece slipped in the switch actuator, as described further with respect to FIG. 4. Attachment means 144, which can be a screw, nail, or other suitable fixture, holds actuator 142 in place and can be anchored into a moving contact of high voltage switch assembly 160.

Similarly, actuator 142 can include one or more guides 146, optionally located on either side of the attachment means 144. Each guide 146 guides travel down and contact a top surface of the moveable contact 162 to distribute a force of the actuator 142 on a top surface of the contact 162 to make it move into engagement with the stationary contacts 164 and 166.

In some cases, a spring is also threaded around each of the guides, extending from the respective guide to the movable contact 162. The springs assist with pushing the actuator 142 back upwards when the force is released.

Actuator 142 can include one or more insulators 148 surrounding the attachment means 144 and/or the guides 146. The insulators 148 insulate the actuator 142 and various components from the stationary contacts 162, 164, and 166.

Actuator 142 interfaces with high voltage switch assembly 160 such that when the plunger rod 114 is in the normal position, the actuator 142 holds the moveable contact 162 in a separated position from stationary contacts 164 and 166. By contrast, when the plunger rod 114 is in the depressed position, actuator 142 compresses the moveable contact 162 onto a part of stationary contact 164 and a part of stationary contact 166, thereby completing an electrical circuit from stationary contact 164 to stationary contact 166 and vice versa.

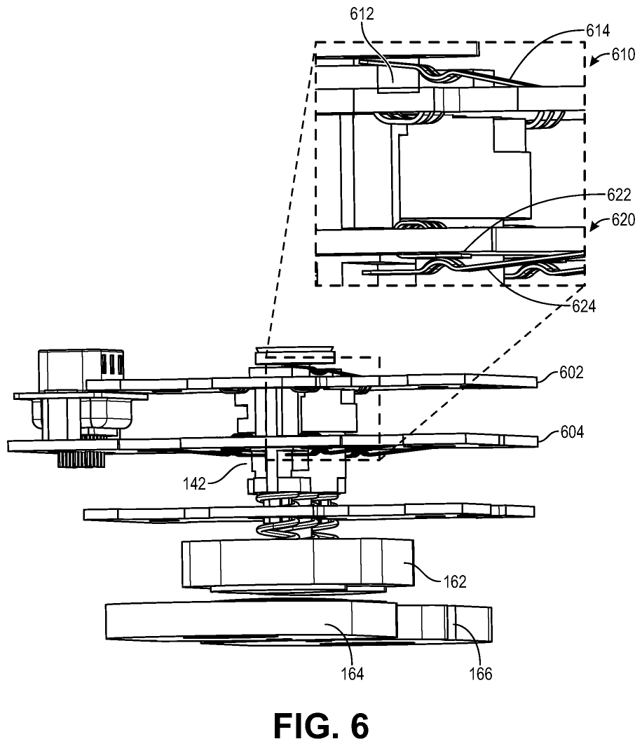

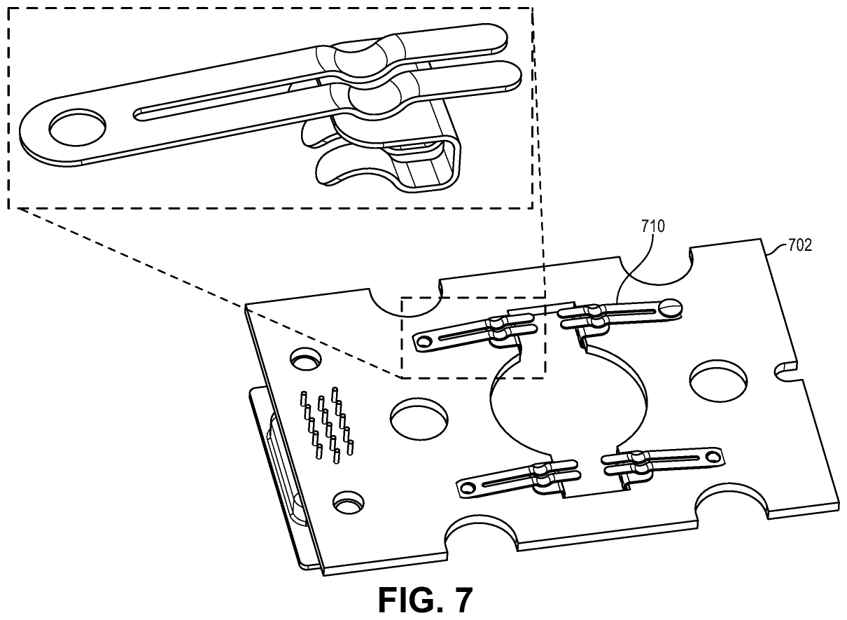

Low voltage switch assembly 170 includes one or more auxiliary switches. Examples of use cases for auxiliary switches include switching secondary circuits or for providing feedback to a user of the switch (e.g., via a status light). Low voltage switch assembly 170 includes one or more stationary low voltage contacts and movable low voltage contacts. Low voltage switch assembly 170 is further depicted in FIGS. 6 and 7. Actuator assembly 140 can include one or more ridges (not depicted) that when the actuator 142 is moves by plunger rod 114, the ridges open or close one or more of the low voltage contacts.

For example, in the normal position, actuator 142 causes a first stationary low voltage contact and a first movable low voltage contact to be separated (normally open) and a second stationary low voltage contact and a second movable low voltage contact to contact (normally closed). In the depressed position, actuator 142 causes the first stationary low voltage contact and a first movable low voltage contact to contact and the second stationary low voltage contact and a second movable low voltage contact to separate.

Actuator 142 moves contacts in both the high voltage switch assembly 160 and low voltage switch assembly 170 in unison. For example, when in the normal position, plunger rod 114 causes the actuator to simultaneously (i) separate the movable high voltage contact 162 from the stationary contacts 164, 166 and (ii) the ridges to toggle the movable low voltage contact and the stationary low voltage contact. Conversely, when in the depressed position, plunger rod 114 causes the actuator to move the movable high voltage contact to contact with the pair of stationary high voltage contacts and the ridges to toggle the movable low voltage contact and the stationary low voltage contact.

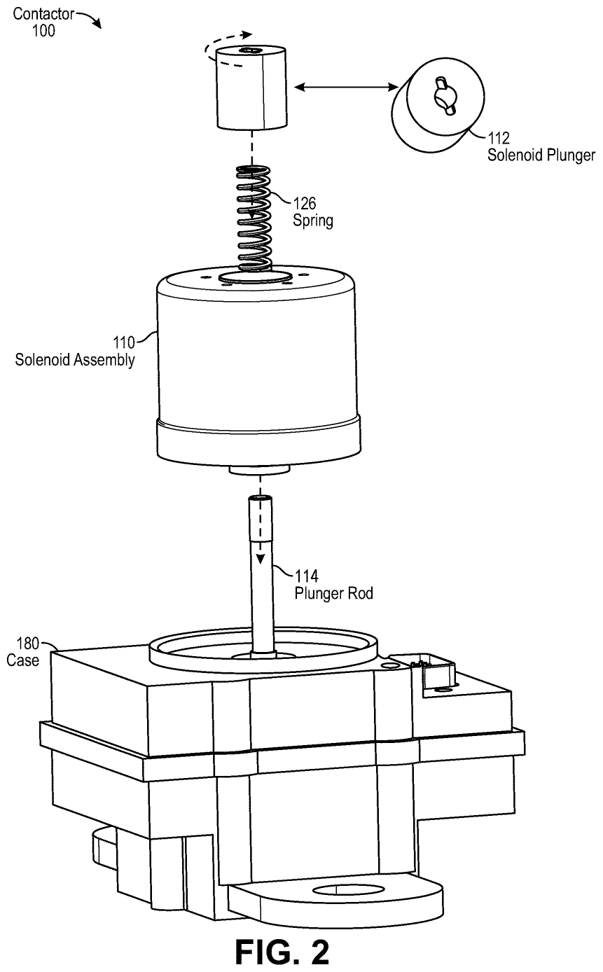

FIG. 2 is a view of a plunger assembly of an electrical contactor, according to certain embodiments of the present invention. FIG. 2 depicts contactor 100, plunger rod 114, solenoid assembly 110, spring 126 and case 180. As shown, the solenoid assembly 110 is assembled by inserting solenoid plunger 112 into spring 126, which in turn is inserted into solenoid assembly 110, over the plunger rod 114, joining to actuator assembly 140.

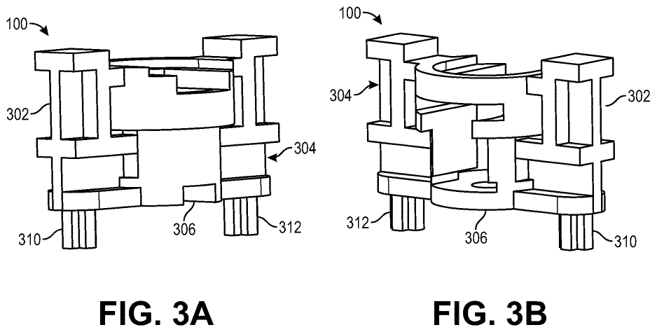

FIG. 3, which includes FIGS. 3A and 3B, depicts views of an actuator of contactor 100, according to certain embodiments of the present invention. FIG. 3A depicts a first side view of actuator 142 of contactor 100. FIG. 3B depicts a second side view of actuator 142 of contactor 100, which is rotated approximately 180 degrees with respect to FIG. 3A.

Actuator 142 includes at least three portions: a first portion 302, a second portion 304, and a middle portion 306 that is located between the first portion 302 and the second portion 304. Each of the first portion 302 and second portion 304 include a guide, specifically first portion includes guide 310 and second portion includes guide 312. The guides 310 and 312 are examples of the guides 146 described with respect to FIG. 1. Each guide 310 and 312 can mate with a portion of a stationary high voltage electrical contact (e.g., stationary electrical contacts 164, 166). In this manner, the actuator 142 is stable.

FIG. 4, which includes FIGS. 4A, 4B, 4C, and 4D, depicts an attachment of a switch actuator to a contact, according to certain embodiments of the present invention, FIG. 4 details attachment of actuator 142 to movable contact 162 using attachment means 144 and washer 452.

FIG. 4A depicts a front view of actuator 142 and movable contact 162 in which washer 452 is inserted into actuator 142. FIG. 4B depicts a rear view of actuator 142 and movable contact 162 in which washer 452 is inserted into actuator 142 as attachment means 144 is inserted into the top of actuator 142. FIG. 4C depicts a rear view of actuator 142 and movable contact 162 in which attachment means 142 is tightened into actuator 142. Finally, FIG. 4D depicts a rear-side view of actuator 142 in which attachment means 142 is removed from actuator 142.

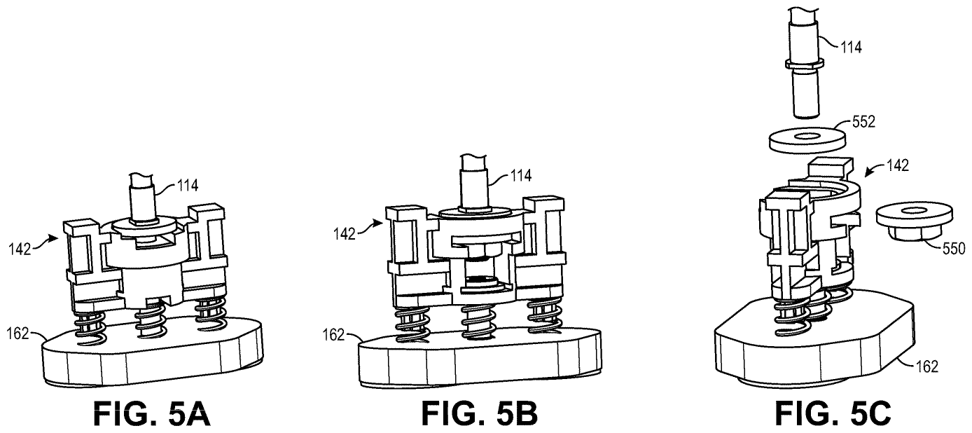

FIG. 5, which includes FIGS SA, 5B, and SC, is a view of a connection of a solenoid plunger rod to an actuator, according to certain embodiments of the present invention. FIG. 5A depicts plunger rod 114, actuator 142, and movable contact 162. Actuator 142 is attached to movable contact 162 via attachment means 144. FIG. 5B depicts a rear view relative to FIG. 5A.

FIG. 5C depicts an example of an attachment of plunger rod 114 to actuator 142. The attachment means 144 is inserted into actuator 142 and anchored. Then, nut 550 is inserted upside-down and above attachment means 144. Plunger rod 114 is then inserted, through washer 552, through the top of the middle portion of actuator 142 into nut 550. A final rotation of plunger rod 114 secures the moving actuator. The plunger rotation can then be easily used to perfectly set the switch arc gaps for the high current switch and the auxiliary switches all at the same time. No additional adjustment or additional parts are needed.

FIG. 6 is a view of an auxiliary board assembly on an actuator, according to certain embodiments of the present invention. FIG. 6 depicts a view of actuator 142 alongside various components including circuit boards 602 and 604. Circuit boards 602 and 604 encircle the actuator 142 such that the actuator 142 moves within the circuit boards 602 and 604, thereby opening or closing one or more low voltage contacts. Contacts 610 and 612 are located on a circuit board installed between the coil and the high current switch.

Circuit board 602 includes normally open switch 610, with contacts 612 and 614. As actuator 142 moves from the normal to the depressed position, the actuator moves contact 614 such that it makes contact with contact 612. Circuit board 604 includes normally closed switch 620, with contacts 622 and 624. As actuator 142 moves from the normal to the depressed position, the actuator moves contact 624 such that it breaks contact with contact 622.

Other contact types and arrangements are possible on the circuit boards. Examples include a pair of plug and socket type contacts, contacts that are soldered to the circuit boards, contacts that are removable from the circuit boards, and so forth.

FIG. 7 is a view of a low voltage switch assembly of the actuator, according to certain embodiments of the present invention. FIG. 7 depicts circuit board 702 with contact 710. Circuit board 702 is an example of circuit boards 610 or 612. As can be seen, contact 710 is a spoon-shape. Contact 710 is actuated by one or more ridges on actuator 142.

In the following, further examples are described to facilitate the understanding of the invention.

An electrical contactor including: a solenoid assembly including a plunger rod and configured to maintain the plunger rod in at least a normal position and a depressed position; a high voltage switch assembly configured to receive the plunger rod and including: a pair of stationary high voltage contacts; an actuator configured to receive the plunger rod and including one or more guides, each guide operable to mate with a respective stationary high voltage contact; and a movable high voltage contact connected to the actuator and movable by the plunger rod; and a low voltage switch assembly configured to receive the plunger rod and including: a stationary low voltage contact; a movable low voltage contact, movable by one or more ridges attached to the actuator, wherein the ridges cause the low voltage switch assembly to toggle between a first position wherein the movable low voltage contact contacts the stationary low voltage contact, and a second position wherein the movable low voltage contact does not contact the stationary low voltage contact, and wherein: when in the normal position, the plunger rod causes the actuator to simultaneously (i) separate the movable high voltage contact from the pair of stationary high voltage contacts and the plunger rod causes (ii) the ridges to toggle the movable low voltage contact and the stationary low voltage contact, and when in the depressed position, the plunger rod causes the actuator to (i) move the movable high voltage contact to contact with the pair of stationary high voltage contacts and (ii) the ridges to toggle the movable low voltage contact and the stationary low voltage contact.

The electrical contactor of any previous or subsequent illustration, wherein when in the normal position, each of the one or more guides mates with its respective stationary high voltage contact.

The electrical contactor of any previous or subsequent illustration, wherein the movable high voltage contact includes an opening to receive, when the plunger rod is depressed, a portion of the actuator.

The electrical contactor of any previous or subsequent illustration, further including one or more insulators positioned between the guide and the actuator or between the opening and the actuator.

The electrical contactor of any previous or subsequent illustration, wherein the solenoid assembly includes: a solenoid plunger configured to receive the plunger rod and to maintain the plunger rod in at least a normal position and a depressed position, and a spring configured to compress when the solenoid plunger is in the depressed position and to return the plunger rod to the normal position.

The electrical contactor of any previous or subsequent illustration, wherein the actuator is formed of plastic.

The electrical contactor of any previous or subsequent illustration, wherein the guide is a screw.

The electrical contactor of any previous or subsequent illustration, wherein the actuator is formed of plastic.

The electrical contactor of any previous or subsequent illustration, wherein the separating ensures that the movable high voltage contact to contact with the pair of stationary high voltage contacts are not in contact.

A switch including: a plunger assembly including a plunger rod; an actuator connected to the plunger rod; a movable high voltage contact connected to the actuator; a low voltage switch assembly, including: a stationary low voltage contact; and a movable low voltage contact; and a pair of stationary high voltage contacts; wherein the actuator and the plunger rod are configured to move between a first position and a second position, wherein when the first position, the movable high voltage contact is separated from the pair of stationary high voltage contacts and the movable low voltage contact is separated from the stationary low voltage contacts, and wherein when in the second position, the movable high voltage contact makes contact with the pair of stationary high voltage contacts and the movable low voltage contact makes contact with the stationary low voltage contacts.

An actuator of an electrical contactor, the actuator including: a first portion including a first guide extending through a first spring and operable to mate with a first stationary high voltage contact; a second portion including a second guide extending through a second spring and operable to mate with a second stationary high voltage contact; a middle portion located between the first portion and the second portion, wherein the middle portion is circular, wherein the middle portion is configured to receive an attachment means, and wherein the attachment means attaches the actuator to one or more of the first stationary high voltage contact and the second stationary high voltage contact.

The electrical contactor of any previous or subsequent illustration, wherein the actuator is formed of plastic and wherein the attachment means is a screw. Different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications may be made without departing from the scope of the claims below.

That which is claimed is:

1. An electrical contactor comprising:
a solenoid assembly comprising a plunger rod and configured to maintain the plunger rod in at least a normal position and a depressed position;
a high voltage switch assembly configured to receive the plunger rod and comprising:
a pair of stationary high voltage contacts;
an actuator configured to receive the plunger rod and comprising one or more guides, each guide operable to mate with a respective stationary high voltage contact; and
a movable high voltage contact connected to the actuator and movable by the plunger rod; and
a low voltage switch assembly configured to receive the plunger rod and comprising:
a stationary low voltage contact,
a movable low voltage contact, movable by one or more ridges attached to the actuator, wherein the ridges cause the low voltage switch assembly to toggle between a first position wherein the movable low voltage contact contacts the stationary low voltage contact, and a second position wherein the movable low voltage contact does not contact the stationary low voltage contact, and wherein:
when in the normal position, the plunger rod causes the actuator to simultaneously (i) separate the movable high voltage contact from the pair of stationary high voltage contacts and the plunger rod causes (ii) the ridges to toggle the movable low voltage contact and the stationary low voltage contact, and
when in the depressed position, the plunger rod causes the actuator to (i) move the movable high voltage contact to contact with the pair of stationary high voltage contacts and (ii) the ridges to toggle the movable low voltage contact and the stationary low voltage contact.

2. The electrical contactor of claim 1, wherein when in the normal position, each of the one or more guides mates with its respective stationary high voltage contact.

3. The electrical contactor of claim 1, wherein the movable high voltage contact comprises an opening to receive, when the plunger rod is depressed, a portion of the actuator.

4. The electrical contactor of claim 2, further comprising one or more insulators positioned between the guide and the actuator or between the opening and the actuator.

5. The electrical contactor of claim 1, wherein the solenoid assembly comprises:
a solenoid plunger configured to receive the plunger rod and to maintain the plunger rod in at least a normal position and a depressed position; and
a spring configured to compress when the solenoid plunger is in the depressed position and to return the plunger rod to the normal position.

6. The electrical contactor of claim 1, wherein the actuator is formed of plastic.

7. The electrical contactor of claim 1, wherein the guide is a screw.

8. The electrical contactor of claim 1, wherein the actuator is formed of plastic.

9. The electrical contactor of claim 1, wherein the separating ensures that the movable high voltage contact to contact with the pair of stationary high voltage contacts are not in contact.

10. A switch comprising:
a plunger assembly comprising a plunger rod;
an actuator connected to the plunger rod;
a movable high voltage contact connected to the actuator;
a low voltage switch assembly, comprising:
a stationary low voltage contact; and
a movable low voltage contact; and
a pair of stationary high voltage contacts;
wherein the actuator and the plunger rod are configured to move between a first position and a second position, wherein when the first position, the movable high voltage contact is separated from the pair of stationary high voltage contacts and the movable low voltage contact is separated from the stationary low voltage contacts, and wherein when in the second position, the movable high voltage contact makes contact with the pair of stationary high voltage contacts and the movable low voltage contact makes contact with the stationary low voltage contacts.

11. An actuator of an electrical contactor, the actuator comprising:
a first portion comprising a first guide extending through a first spring and operable to mate with a first stationary high voltage contact;
a second portion comprising a second guide extending through a second spring and operable to mate with a second stationary high voltage contact;
a middle portion located between the first portion and the second portion, wherein the middle portion is circular, wherein the middle portion is configured to receive an attachment means, and wherein the attachment means attaches the actuator to one or more of the first stationary high voltage contact and the second stationary high voltage contact.

12. The electrical contactor of claim 11, wherein the actuator is formed of plastic and wherein the attachment means is a screw.
